(19) United States
(12) Patent Application Publication
(10) Pub. No.: US 2011/0246823 A1
(43) Pub. Date: Oct. 6, 2011

(54) TASK-ORIENTED NODE-CENTRIC CHECKPOINTING (TONCC)

(75) Inventors: Rishi L. Khan, Wilmington, DE (US); Guang R. Gao, Newark, DE (US); Apperson H. Johnson, Wilmington, DE (US)

(73) Assignee: ET International, Inc., Newark, DE (US)

(21) Appl. No.: 13/080,590

(22) Filed: Apr. 5, 2011

Related U.S. Application Data
(60) Provisional application No. 61/320,813, filed on Apr. 5, 2010.

(51) Int. Cl. G06F 11/07

(52) U.S. Cl. 714/16; 714/E11.023

(57) ABSTRACT

Node-centric checkpointing may be used in a multi-node computing system to provide fault-tolerance. Such checkpointing may involve storage of input and/or output data prior to and/or after execution of a task on a node.

### CROSS-REFERENCE TO RELATED APPLICATION

This Application claims the benefit of priority of U.S. Provisional Patent Application No. 61/320,813, filed Apr. 5, 2010, entitled “Task-Oriented Node-Centric Checkpointing,” which is incorporated herein by reference in its entirety.

### FIELD OF ENDEAVOR

Embodiments of the present invention may relate generally to the field of data processing, system control, and data communications, and more specifically to an integrated method, system, and apparatus that may provide resilient and efficient computational task and computational resource management, especially for large, many-component tasks that are executed on multiple processing elements.

Embodiments of the invention may also generally address fault-tolerant computing in computing systems having multiple interacting nodes.

### BACKGROUND

Modern high-end computer (HEC) architectures may embody thousands to millions of processing elements, together with networking and storage resources, often processing jobs with execution times of weeks or even months. The large number of processors and extended duration of computation guarantee that even highly reliable computing systems are likely to experience point failures during the span of some computations. Some measures that mitigate system unreliability may include: requirement of higher reliability in processing elements; use of redundant processing or voting circuits to provide fail-over; and running system components well below their peak capabilities; but each of these measures may cause significant increases in computation and/or equipment costs, and may additionally reduce system throughput.

In HEC applications, job execution times can far exceed System Mean-Time Between Failures (SMTBF), leading to inefficient use of the available resources. Long-running execution times involving many processors may impair Reliability, Availability, and Serviceability (RAS) of systems—introducing a high hurdle for system administrators and support staff With large numbers of components that can fail, such as computation nodes, communication paths, and storage resources, the System Mean-Time Between Failures (SMTBF) scaling is approximately inversely proportional to the number of nodes used and can result in an Application Mean-Time Between Interrupts (AMTBI) of just a few hours or less. Typically, parallel applications deal with this by frequently preserving the current state of the computation, and after a failure, restarting and continuing the computation from the most recent previously saved state. As a consequence of this current paradigm, AMTBI=SMTBF, and any non-recoverable component failure of the portion of the system used by the application will result in the termination of the job.

Computing systems have been developed using large numbers of computing devices (which will be generically referred to as “nodes” herein) interacting in in both parallel and pipelined fashion. Such systems have made possible dramatic increases in overall computing power. Examples of such systems include IBM Corporation's BlueGene/L®, BlueGene/P®, and Cyclops-64® computing systems.

One problem that occurs in such systems is that of node failure, either because of a malfunction of the node itself or because of faulty communication links with one or more other nodes. Such failures may need to be detected and accommodated in order to maintain satisfactory functionality of the overall system. Checkpointing, in which a current state is stored, in the middle of execution of an application (in order to facilitate recovery in the event of a failure) can be used for detecting and mitigating node failures in such systems.

Some known checkpointing techniques may require that the user initiate the checkpointing process. Many known checkpointing techniques may also be oriented toward checkpointing entire systems, in which case all (or very large amounts) of data may be required. Because of the large granularity of data and system state that must be saved, maintained and restored, the very process of recovery can become significantly time consuming in such systems. At extreme scales, resources and time used in providing recoverable computing can outweigh those spent on productive work.

Embodiments of the present invention may address the HEC reliable computing problem by providing fine-grained reliability mechanisms that may be used to support task restarts within the execution of a large or long-running application. Such embodiments may provide decoupling of AMTBI and STBF for the case of communication failures, and may allow small portions of computing tasks to be transferred on the occasion of node failure, so that computation may be able to continue without large-scale restart of processes. The approach found in embodiments of the invention, generally referred to herein as task-oriented node-centric checkpointing (TONCC), may utilize local persistent storage to support checkpointing of a large amount of data while avoiding access bottlenecks typically encountered with global DRAM.

Glossary of Terms

Application Programmer Interface (API): a set of programmer-accessible procedures that expose the functionality of a system to manipulation by programs written by application developers who do not necessarily have access to the internal components of the system, or may desire a less complex or more consistent interface than that which is available via the underlying functionality of the system, or may desire an interface that adheres to particular standards of interoperation.

Checkpoint: In fault-tolerant computing, a checkpoint is a representation of computational state that can be stored, and from which subsequent computation can be restarted. This may be used to prevent loss of computational work that has been accomplished prior to the checkpoint.

Computer-accessible artifact (CAA): An item of information, media, work, data, or representation that can be stored, accessed, and communicated by a computer.

Logical Node: A logical representative of the processing resource represented by a physical node. A logical node is typically mapped to a physical node, but that mapping may be changed, for instance, if the physical node fails, or if it is desirable to implement the logical node on a different physical node.

Node: An architectural unit of a computing system, typically encompassing, but not limited to, one or more thread processors, local memory, logic to execute instructions and an ability to receive data from off-chip components and to provide data to off-chip components, and more generally defined as any computing device connected to a computer network.

Generalized Actor (GACT): one user or a group of users, or a group of users and software agents, or a computational entity acting in the role of a user, which behaves in a way to achieve some goal.

Local Area Network (LAN): Connects computers and other network devices over a relatively small distance, usually, but not necessarily, within a single organization.

Wide Area Network (WAN): Connects computers and other network devices over a potentially large geographic area.

Scalability: The ability of a computer system, architecture, network or process which allows it to pragmatically meet demands for larger amounts of processing by use of additional processors, memory, and connectivity.

Task: Typically a unified set of data manipulations, performed by one or more processors or thread units that accomplishes some resulting desired data value or data relationships. For the purposes of this application, a “task” will be defined as a set of computations that requires no communication with other nodes. Note that this does not exclude communication between threads running on the same node.

Thread: A thread is a small unit of processing. Typically, in multi-threaded systems, processes are composed of multiple threads, and may accomplish high-level jobs as applications or as services.

### SUMMARY

Various embodiments of the instant invention may provide several novel approaches for reliable multi-processor computing, which may include using logical nodes to perform a computation to accomplish a computational tasks, storing result the tasks to local persistent storage associated nodes, storing result computational task to local persistent storage of another node, using the accomplish a second computational task, wherein the second task that requires result from the first computational task; and permitting the second task to be restarted. Embodiments of the invention may also provide users with a representational construct capable of specifying computational tasks and their relationships and, using those relationships, to permit tasks to be restarted as needed.

### BRIEF DESCRIPTION OF THE DRAWINGS

FIG. 1 illustrates an Exemplary Task Checkpointing Method—Stage (A)

FIG. 2 illustrates an Exemplary Task Checkpointing Method—Stage (B)

FIG. 3 illustrates an Exemplary Task Checkpointing Method—Stage (C)

FIG. 4 illustrates an Exemplary Task Checkpointing Method—Stage (D)

FIG. 5 illustrates an Exemplary Task Checkpointing Method—Stage (E)

FIG. 6 illustrates an Exemplary Task Checkpointing Use Case

FIG. 7 illustrates an Exemplary Architecture—Chip Level

FIG. 8.1 illustrates an Exemplary Architecture—Board/System Level

FIG. 9 illustrates an Exemplary Isolation of Tasks by Explicit Language Element

FIG. 10 illustrates an Exemplary Resource Clustering—Run History Analysis

FIG. 11 illustrates an Exemplary Resource Clustering—Dynamic Run Analysis

FIG. 12 illustrates an Exemplary Dynamic Run Analysis—Sampling

### DETAILED DESCRIPTION OF VARIOUS EMBODIMENTS

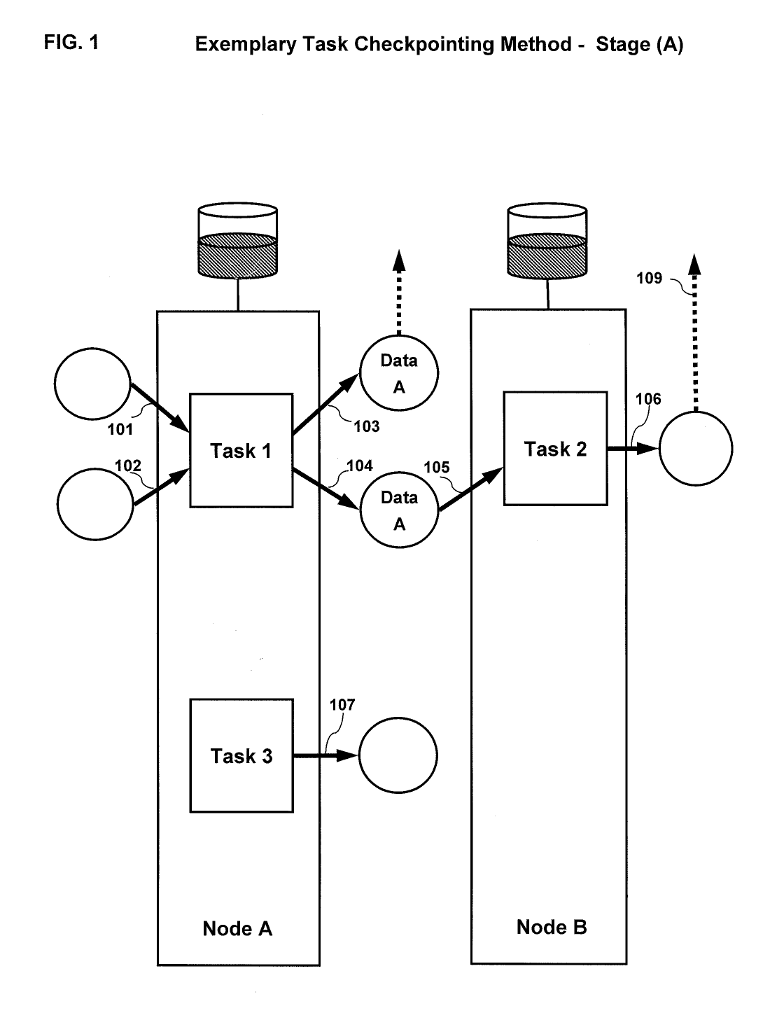

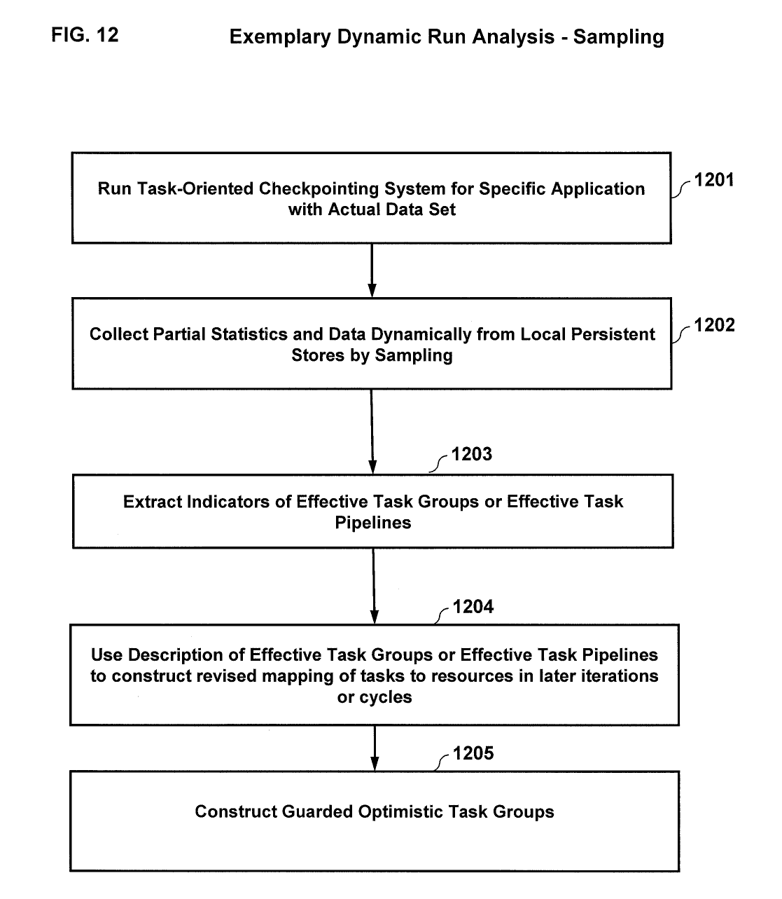

FIG. 1. through FIG. 12 illustrate conceptual block/flow diagrams that may be used to describe various embodiments of the invention. A task may be characterized, in part, by its inputs and/or outputs, which may correspond to memory positions and/or data sizes. A logical node will be considered to have been “respawned” when the task(s) that was/were running (or was/were supposed to run) on that node is/are redirected to a new, alternative node (which may be a spare node), and inter-node communications are reset to be directed to and from the alternative node.

FIG. 1 illustrates an exemplary embodiment of how embodiments of the invention may operate. In FIG. 1, rectangles represent tasks, circles represent data, and input/output (I/O) directions are represented by the directions of the arrows connecting the data to tasks. In the example of FIG. 1, Node A is shown running Task 1, and Node B is shown running Task 2.

Part of the operation of embodiments of the invention may involve the persistent storage of data input to and/or output from a particular node. In the example of FIG. 1, for example, the input data for Task 1 may be stored persistently somewhere in the system.

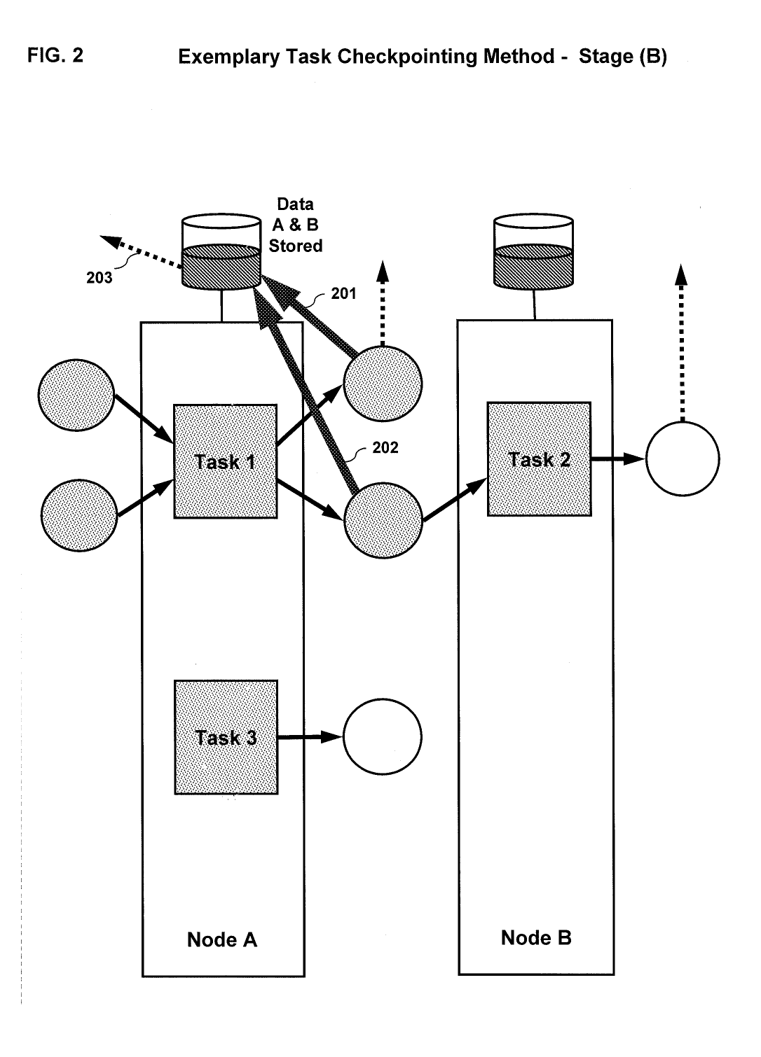

When Task 1 finishes, it may then send data to Task 2, shown on Node B and/or to other tasks running on other nodes (not shown) and/or may be output as overall system output (not shown). According to an embodiment of the invention, when Task 1 finishes, Node A may store the output of Task 1 in its local persistent storage, as shown in FIG. 2; in some embodiments of the invention, this output data may be transparently mirrored across the persistent storage associated with other nodes, as well. If Logical Node A fails before completing Task 1, it may be respawned, and Task 1 may begin anew on the respawned logical node, may be mapped to a new physical node, using the backed-up input data. If Logical Node A fails after completing Task 1, the output data has been stored in persistent storage, so copies of the backed-up data may be sent to the various receiving nodes (e.g., Logical Node B).

At the same time, the output data from Task 1 may be sent to Logical Node B for use in Task 2. Logical Node B/Task 2 may then store the data locally in memory, and may begin execution when all input data arrives (noting that data may be received from sources other than the output of Task 1, in general), as shown in FIG. 2 (note that Logical Node A/Task 1 may still have a copy of the data stored in its persistent memory).

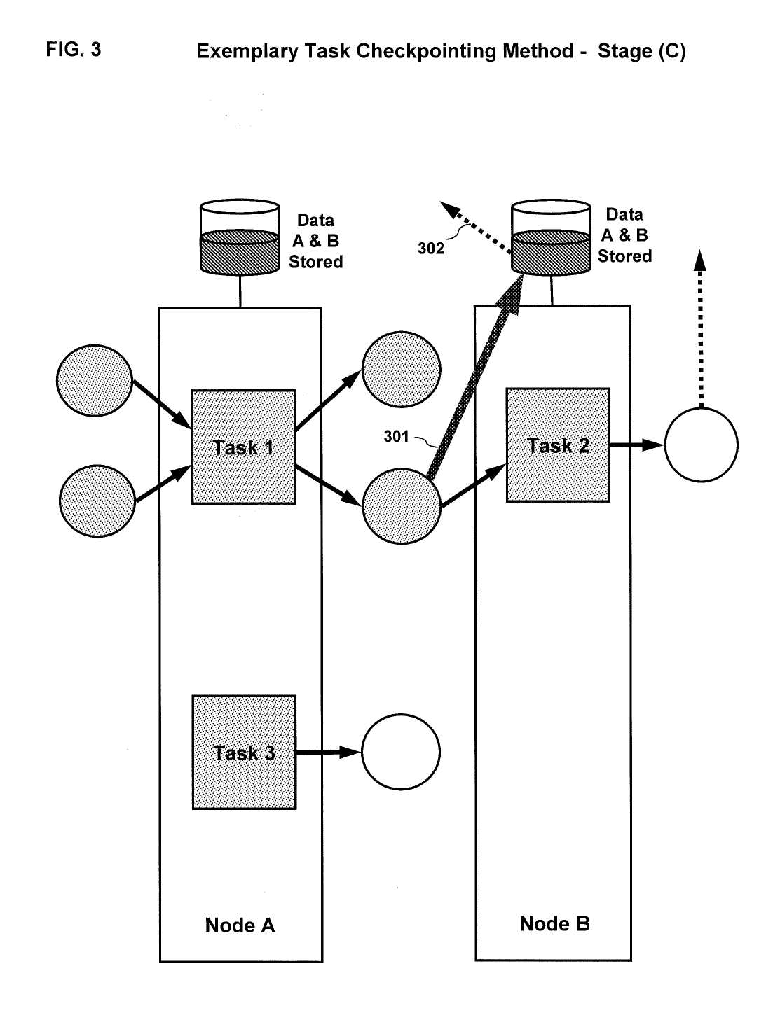

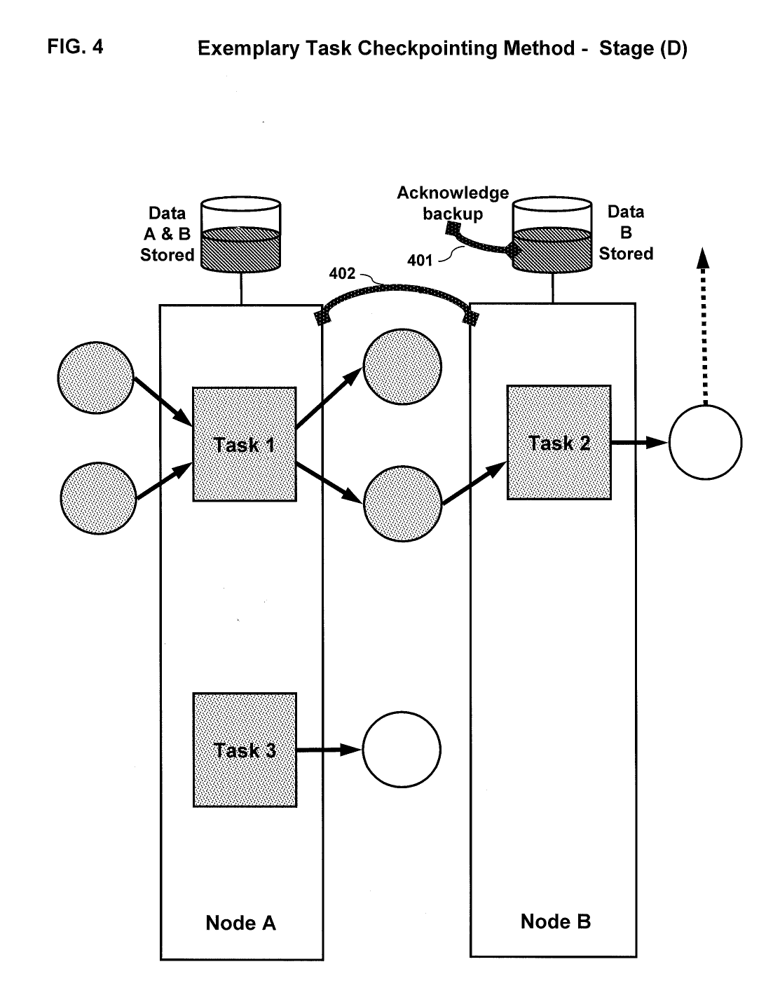

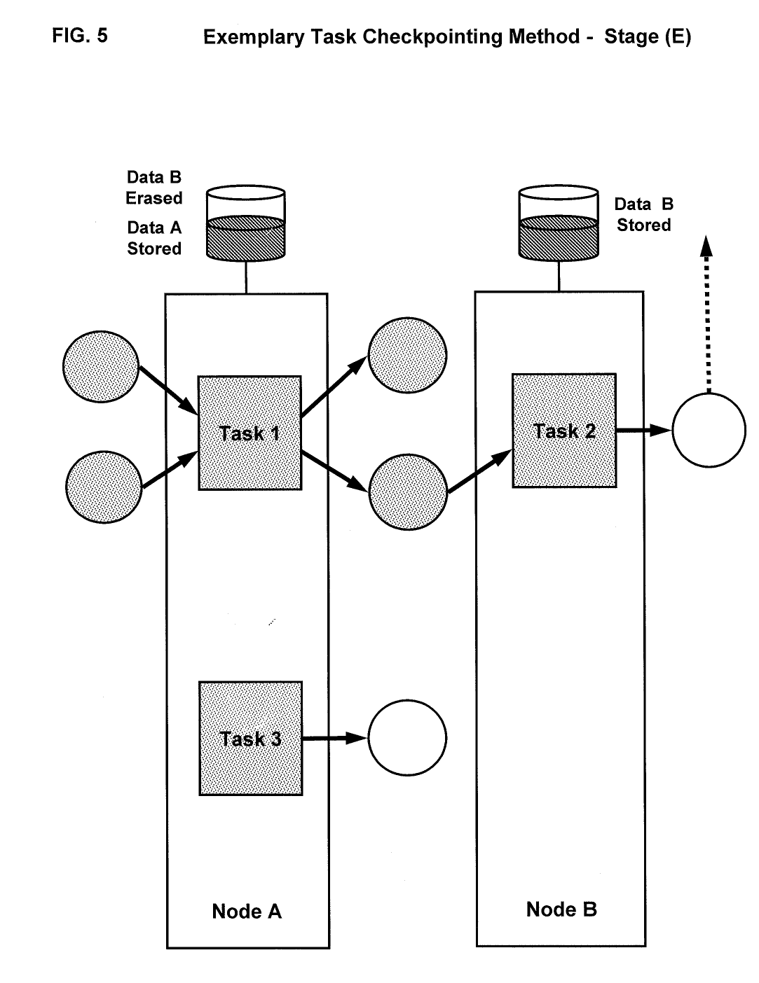

As shown in FIG. 3, Logical Node B, the node running Task 2, may also store the input data as a checkpoint in its local persistent storage (which, again, may also be mirrored across other nodes' persistent storage). Once this input data checkpointing and backup is complete, the Logical Node B may then send a message to Logical Node A to notify Logical Node A of checkpoint completion, as shown in FIG. 4. Consequently, once the output data has been checkpointed at the sending task's node, the data shared between tasks is stored in the system in at least two places, which may provide redundancy in case of failure. As shown in FIG. 5, after the data has been checkpointed by Logical Node B (and/or other nodes to which it was sent as input), Logical Node A may then erase the data from its local persistent storage.

In embodiments of the invention, as shown in FIG. 1, the latency of the input data checkpointing may be hidden from Task 2 without data loss by allowing Task 2 to begin as soon as all of its data is available. If Logical Node B fails before Task 2 completes, Task 2 may be respawned on a node acting as a substitute for Node B using the backup copy of the input data stored on Logical Node A.

Similarly, another task (e.g., Task 3) may run on Logical Node A once the run-time system begins the output data checkpointing of Task 1, as long as the checkpointed data is not some or all of the input data needed for Task 3. In this latter case, Task 3 may begin as soon as the data is placed in persistent storage and mirrored.

Finally, Logical Node A may start sending the output data from Task 1 to Task 2 on Logical Node B for checkpointing while it is storing its local copy to persistent storage. As long as the compute time is significantly larger than the checkpoint time (e.g., but not limited to, two-fold), the checkpointing latency may be able to be hidden. If a task completes (including output data checkpointing) before the input data is checkpointed, the input data checkpointing may be cancelled.

When a node is detected as failed (by some mechanism such as regular polling intervals from a master node), the system may search for tasks with checkpointed inputs on the failed node's local persistent storage. All of these tasks may then be respawned on other nodes. All tasks that have not started on the failed node but were in the process of starting may be run on a different node.

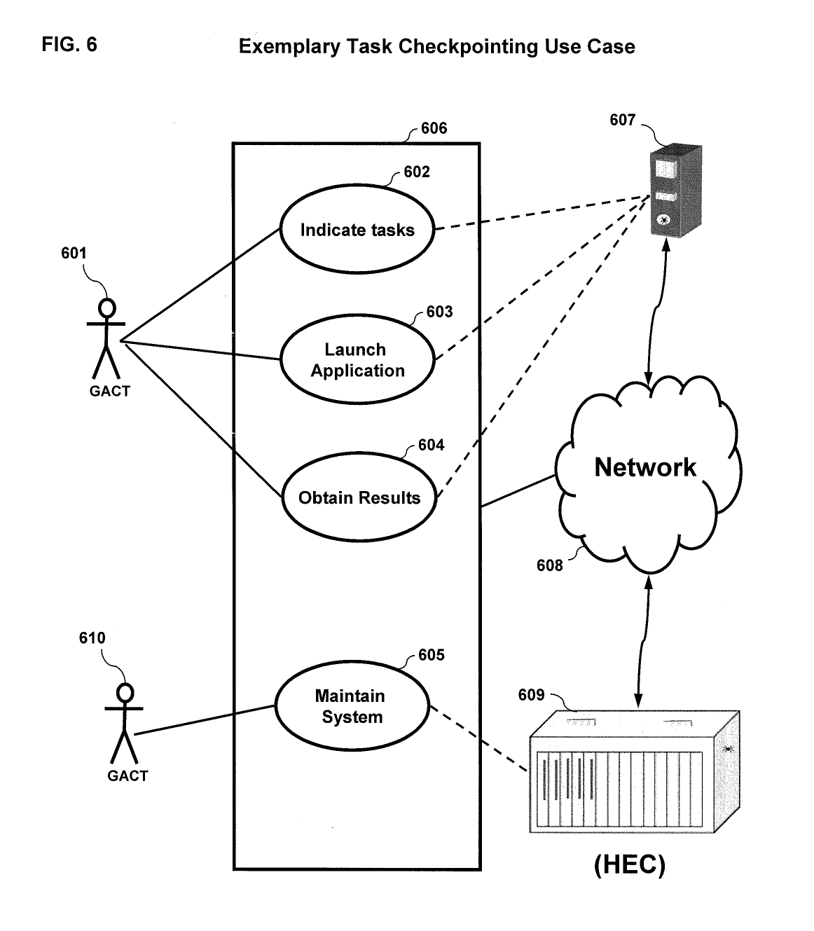

In FIG. 6, a use-case is illustrated in which a generalized actor 601 indicates tasks to be accomplished 602, launches an application 603 composed of such tasks, and obtains results 604. He may accomplish this by interaction with a system interface 606, which may typically be managed by a front-end processor 607, and which in turn may cause tasks to be executed on a HEC 609. In one exemplary embodiment, a generalized actor 610 may perform maintenance 605 through a system interface. In some cases, the system interface may correspond directly while in others, maintenance is performed indirectly through front-end processor 607.

In various embodiments of the invention, a generalized actor 601 or 610 may be provided with one or more of the following for specifying tasks and/or task data dependencies: function definitions, procedure definitions, pragmas, annotations, tags, computer language metadata, computer language macros, computer language objects, computer language templates, declarative language constructs, imperative language constructs, glyphs, symbols, or selection of specified sections of task specification via user-interface choices.

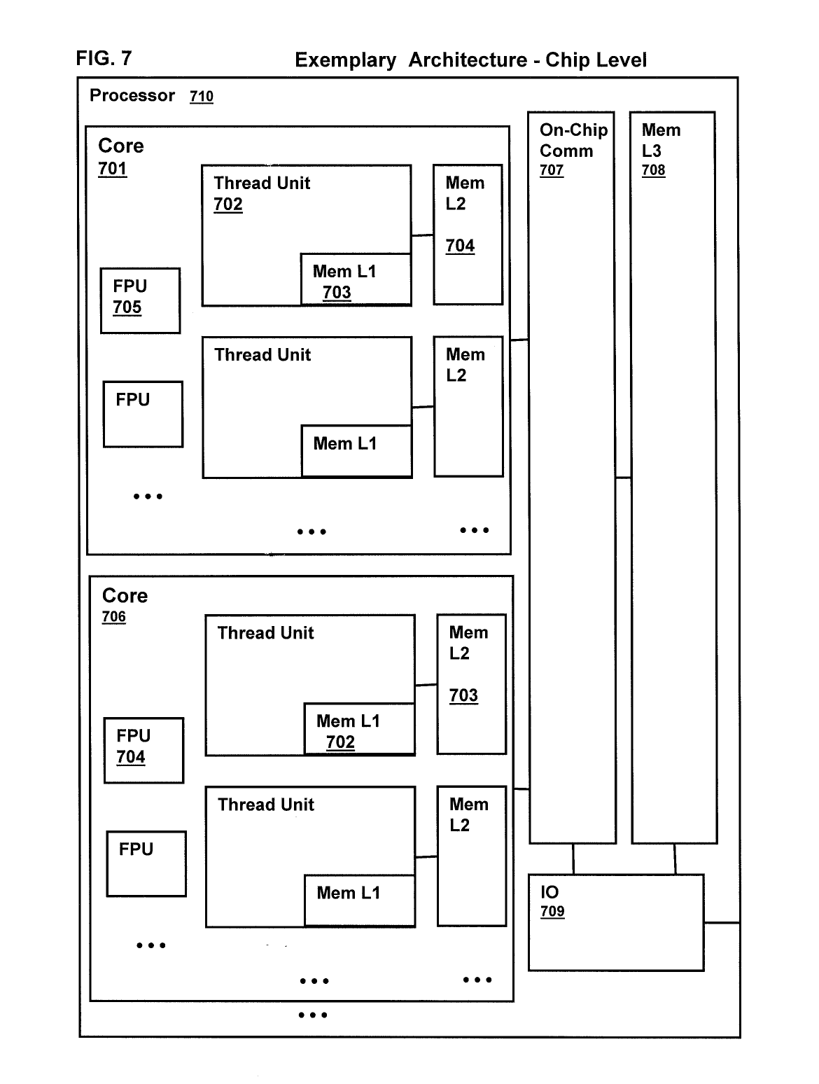

In FIG. 7, an Exemplary Chip Level Architecture is provided that may be used to support various embodiments of the invention. This abstract architecture may include a Processor 701, which may include multiple cores 701, 706. Each core may have multiple thread units, such as thread unit 702, and each thread unit may have access to local Memory L1 703. Note that even though memory is labeled L1, L2, L3, etc., these are indications of locality, and not necessarily indications of caching. Various embodiments of TONCC can be utilized on systems with or without caching at various levels of memory. One or more front-end processing units (FPU) 705 may be available per core, and L2 memory 704 may be directly accessible to all thread units within the core. Note also that the designation of L1, L2, L3 may be applied to purely logical allocation (of the same physical memory), as well as to distinct physical memories. In this exemplary architecture, On-Chip Communications 707 may provide connectivity among the cores, and also between the set of cores and the I/O unit 709. Chip-level memory L3 708 may provide memory for the entire chip; in some embodiments, this may comprise slower, non-local, less expensive memory. Note that not all of these architectural elements are entirely necessary for every implementation. For instance, in some systems, memory can also provide sufficient features of on-chip communication, and I/O. The logical nodes and physical nodes of TONCC may, for example, be mapped to physical thread units such as thread unit 702 for execution. Check-point data can be maintained at any of the L1, L2, L3 locations, as is appropriate for the particular architecture, and for the lifetimes of various tasks, and/or for the currently invested computational resources. In one embodiment, the resources dedicated to maintenance of check-point data may grow with the amount of processing required to reproduce the current computational state.

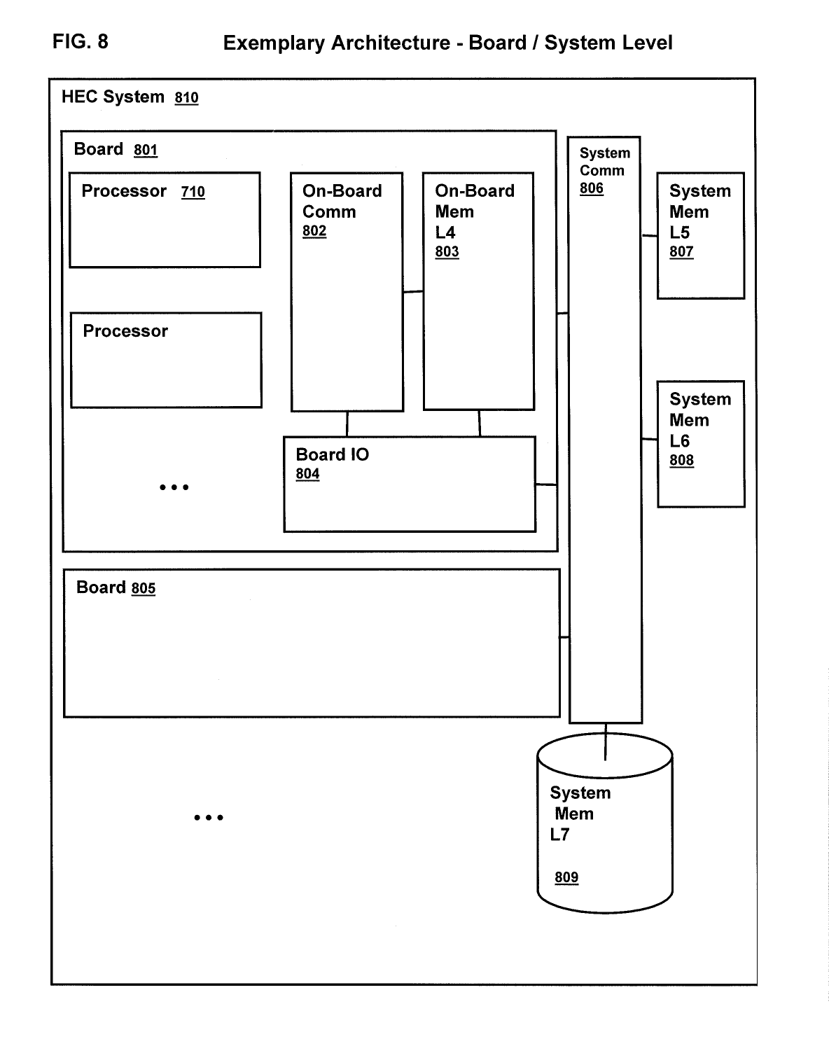

In FIG. 8, an exemplary Board and System Level Architecture is provided that may be used to support some embodiments of the invention. In this architecture, a HEC system 801 may be composed of several levels of system memory L5 807, L6 808, and L7 809—which may represent a hierarchy between fast, more expensive memory and slower, less expensive memory, which may include, in some embodiments, some memory components that are not solid-state memory. A system-wide communication unit 806 may provide communications among various board-level subsystems. A particular board 801 may provide support for any number of processors 701, and may also provide on-board communications 802, and/or board-level memory L4 803, and/or IO 804. In some embodiments, several of these architectural entities may be combined, or elided, given the particular engineering goals of the system. The TONCC system can also use memory at these higher, slower levels to checkpoint larger components of system state, and may use the more general system communication 806 to communicate non-local data, completion, and re-start messages among a larger set of processors.

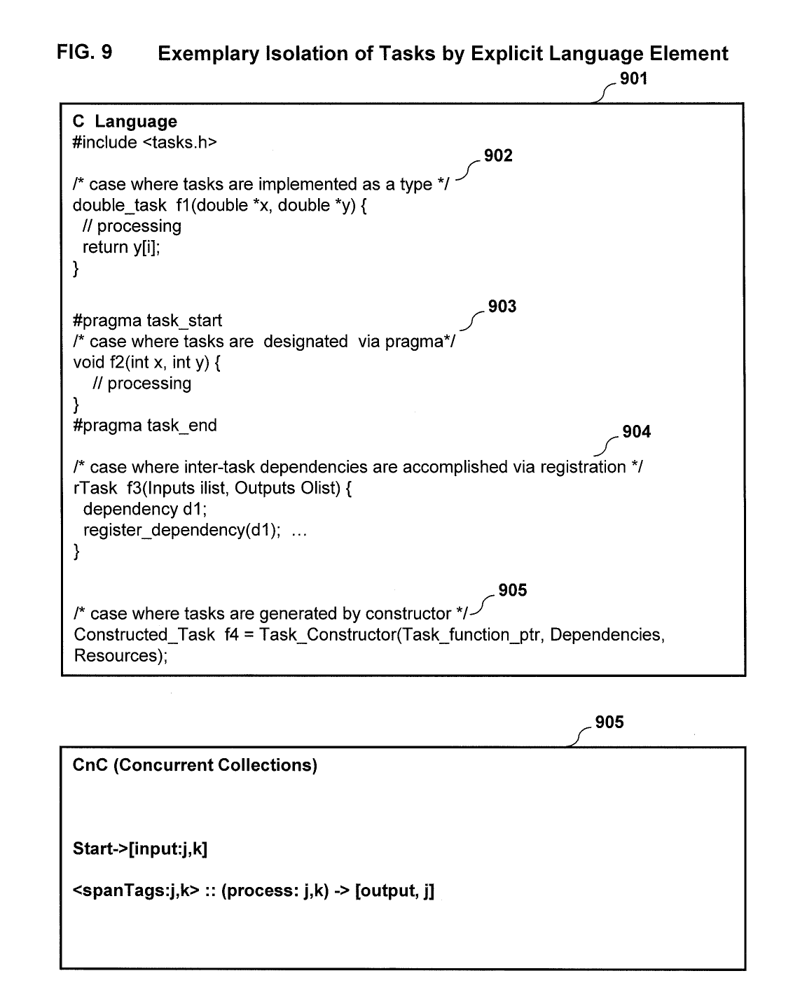

FIG. 9 illustrates an exemplary isolation of tasks by explicit language element. In exemplary code 901, several examples are provided whereby suitable task representations can be constructed within the syntax of mainstream computing languages such as C; however, the inventive concepts are not limited to any particular computing language. In 902, a task can be specified by reference to a previously constructed type “task”. In 903, two pragmas: “task start” and “task end” can be used to demark a task. In 904, a registration task can be created that is responsible for registering its own dependencies. Finally, in 905, a Constructed Task f4 may be the output of a constructor function that can behave as a factory for tasks. In 905, a simple example of task components, which can, for example, be created in the CnC language, is given. This is a language particularly aimed at supporting parallel processing. Skilled practitioners will see how these representation strategies can be used in virtually all other programming languages, such as C++, C#, Java, Python, Perl, Ruby, Basic, ADA, Visual Basic, FORTRAN, scheme, clojure, Scala, PROLOG, Haskel, Erlang, Cilk, Curry, Go, and occam.

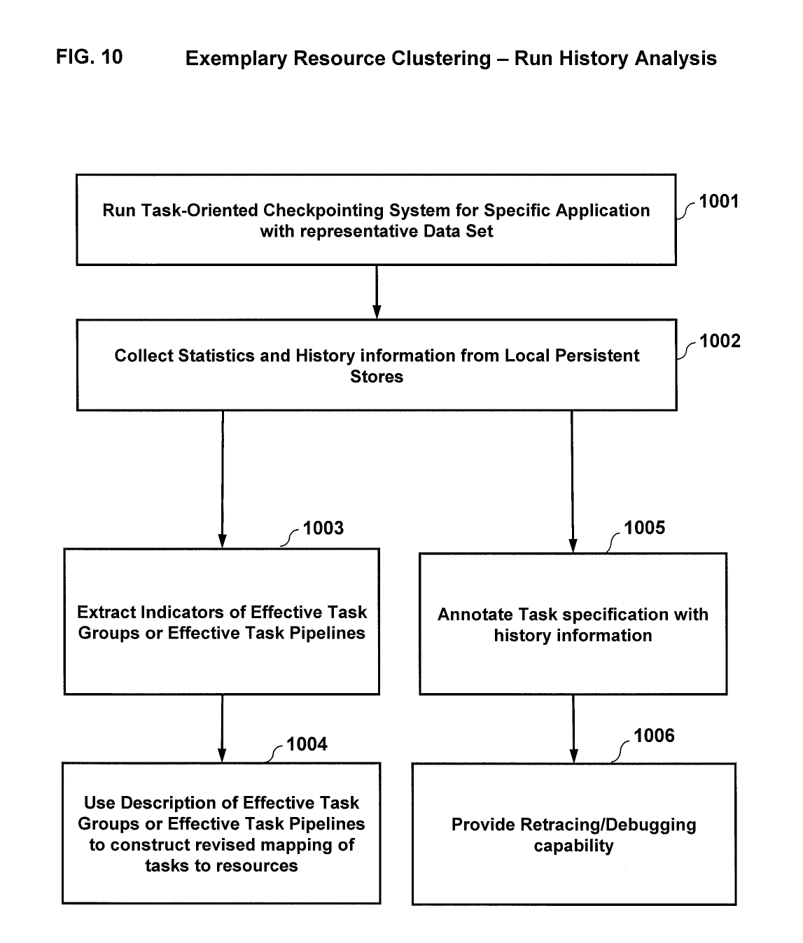

FIG. 10 illustrates an exemplary embodiment of resource clustering—run history analysis. In 1001, a specific application, with representative data, can be run on the TONCC. This may be performed to fill local persistent storage with values typical of a run of the application. In 1002, statistics and history information from local persistent stores may be collected, tagged, and/or consolidated into a single body of data. In 1003, indicators of effective task groups or effective task pipelines can be extracted from the consolidated data. An effective task group is a task group that that can be treated as a unit for purposes of checkpointing and restart. It may generally have a single entry and exit. Note that effective task groups can also be recognized from the task specification. An advantage to using empirically-derived effective task groups is that they may be different from those that are constructed theoretically from inter-task relationships. A disadvantage to empirically-derived effective task groups is that they may not hold for all data inputs or processing paths. Thus, when an empirically-derived effective task group is used as a unit, a special guard may need to be constructed to ensure that its integrity assumption has not been violated. If the integrity is ever violated during a run, the task group may need to be broken into its component parts. A pipeline is a special task group with an entrance and a succession of tasks, wherein each task except the last feeds the next task in the succession. In 1004 description of effective task groups or effective task pipelines can be used to construct revised mapping of tasks to resources. In some embodiments this revised mapping can make more efficient use of checkpointing storage resources, and/or can provide better opportunities for exploiting locality of resources. Note that in 1005 the tagged data and/or statistics can be used to annotate the task specification, and in 1006 the task specification and history data can be used to provide information for retracing execution and/or for debugging that may be used to examine and manipulate the state of a running parallel application.

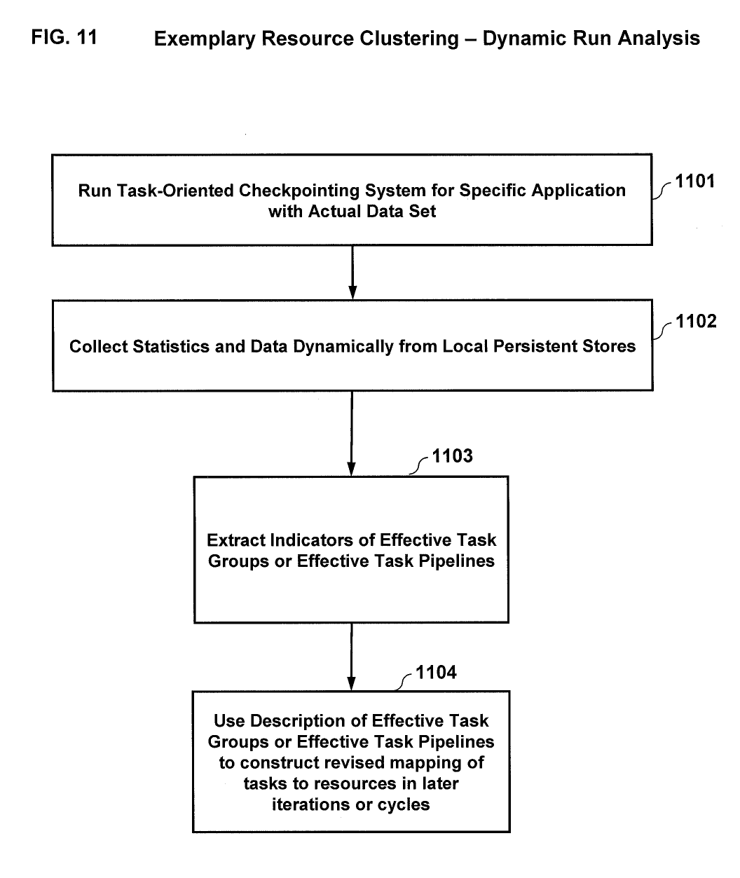

FIG. 11 illustrates an exemplary resource clustering—using dynamic run analysis. In this approach, in 1101, a run task-oriented checkpointing system may be used for execution of a specific application with an actual data set. In 1102, statistics and data may be collected dynamically from local persistent stores, as the application is run. In 1103, indicators of effective task groups or effective task pipelines may be extracted from the statistics and data during the run of the application. In 1104, the description of effective task groups or effective task pipelines may be used to construct revised mapping of tasks to resources in later iterations or cycles of the same application.

FIG. 12 illustrates an exemplary dynamic run analysis—using sampling. In 1201, a run task-oriented checkpointing system may be used for execution of a specific application with an actual data set. In 1202, statistics and data may be collected dynamically from local persistent stores, as the application is run. In 1203, indicators of effective task groups or effective task pipelines may be extracted from the statistics and data during the run of the application. In 1204, the description of effective task groups or effective task pipelines may be used to construct revised mapping of tasks to resources in later iterations or cycles of the same application. In 1205, the revised mapping of tasks may be used to create guarded optimistic task groups. These groups may make assumptions about the unity of task groups, but the assumptions may only be based on sampling of data from local persistent stores. As mentioned previously, integrity guards may be used to guarantee that any assumptions violated by subsequent execution cause the task group to be decomposed to its components.

In the preceding description, various memories and/or processor-readable media have been discussed. Such components may comprise, but are not necessarily limited to the following: SRAM, battery-backed SRAM, FLASH memory, FeRAM, MRAM, PCRAM, CBRAM, SONOS, RRAM, Racetrack memory, Carbon Nanotube Memory, Millipede Memory, solid-state-drives, hard-drives, magnetic recording systems, optical drives, optical recording systems, battery-backed DRAM, battery-backed cache memory, capacitor-backed cache memory, contiguous memory, cache memory, main memory, Random Access Memory (RAM), Dynamic Random Access Memory (DRAM), Double Datarate Synchronous DRAM (DDR), Synchronous DRAM (SDRAM), Fast-Cycle RAM (FCRAM), Magnetic Random Access Memory (MRAM), Non-Volatile Random Access Memory (NVRAM), Read Only Memory (ROM), Electrically Programmable Read Only Memory (EPROM), Electrically Erasable Programmable Read-Only Memory (EEPROM), disk storage, Direct Access Storage Device (DASD), Distributed Mass Storage System (DMSS), High Capacity Storage System (HCSS), Hierarchical Storage Management (HSM), Mass Storage Device (MSD), Mass Storage System (MSS), Multiple Virtual Storage (MVS), Network Attached Storage (NAS), Redundant Arrays of Independent Disks (RAID), Storage/System Area Network (SAN), Storage Data Acceleration (SDX), Serial AT Attachment (SATA) devices, Small Computer System Interface (SCSI) devices, Internet Small Computer System Interface (iSCSI) devices, AT Attachment (ATA) devices, Variable Array Storage Technology (VAST), Virtual Storage (VS), Virtual Storage Extended (VSE), Virtual Shared Memory (VSM), and the like.

Various embodiments of the invention have now been discussed in detail; however, the invention should not be understood as being limited to these embodiments. It should also be appreciated that various modifications, adaptations, and alternative embodiments thereof may be made within the scope and spirit of the present invention.

What is claimed is:

1. A computer-implemented method for performing computation, comprising:
a) using at least one first node of a computing system to perform a computation to accomplish a first computational task;
b) storing at least one result from the first computational task to local persistent storage associated with the first node;
c) storing at least one result from the first computational task to local persistent storage associated with at least one second node of the computing system;
d) using the at least one second node to perform a computation to accomplish a second computational task, wherein the second computational task requires the at least one result from the first computational task; and
e) enabling the second computational task to be restarted using the result from the first computational task stored in the local persistent storage associated with the at least one second node.

2. The method of claim 1, further comprising restarting the second task from a point at which the stored result from the first computational task becomes necessary.

3. The method of claim 1, wherein enabling the second computational task to be restarted comprises enabling the second computational tasks to be restarted if the second computational task fails to complete within specified resource allocations.

4. The method of claim 1, further comprising using a first logical node as the first node and using a second logical node as the second node.

5. The method of claim 1, wherein at least one of the local persistent storage associated
with the first node or the local persistent storage associated with the at least one second node comprises at least one storage type selected from the group consisting of: SRAM, battery-backed SRAM, FLASH memory, FeRAM, MRAM, PCRAM, CBRAM, SONOS, RRAM, Racetrack memory, Carbon Nanotube Memory, Millipede Memory, solid-state-drives, hard-drives, magnetic recording systems, optical drives, optical recording systems, battery-backed DRAM, battery-backed cache memory, and capacitor-backed cache memory.

6. The method of claim 1, further comprising:
a) sending a message from the at least one second node to the first node that the at least one second node has a copy of the at least one result from the first computational task stored in its associated local persistent storage; and
b) causing the first node to erase the at least one result from its associated local persistent storage after it obtains the message from the at least one second node.

7. The method of claim 1, further comprising:
a) permitting the first node to accept new input data corresponding to a third computational task after output data from the first computational task has been stored; and
b) permitting the first node to begin computation of the third computational task as soon as all data inputs required by the third computational task have been obtained in local storage associated with the first node.

8. The method of claim 1, further comprising:
a) storing the at least one result from the first computational task to storage available to a third node; and
b) using the third node to perform the second computational task in the event that the second node fails.

9. The method of claim 1, further comprising:
a) storing the at least one result from the first computational task to a global storage system available to a third node; and
b) using the third node to perform the second computational task in the event that the second node fails.

10. The method of claim 1, further comprising:
a) determining that the second computational task does not need all of its inputs to be available before initial operations of the second computational task are performed;
b) starting the second computational task on the second node before all of the inputs required by the second computational task are available; and
c) restarting the second computational task if the second computational task fails because a required input was not available before that required input is needed.

11. The method of claim 1, further comprising:
a) associating a run location of at least one computational task with at least one computational resource required by the task, wherein said resource is at least one resource selected from the group consisting of
data, contiguous memory, cache memory, main memory, Random Access Memory (RAM), Dynamic Random Access Memory (DRAM), Double Datarate Synchronous DRAM (DDR), Synchronous DRAM (SDRAM), Fast-Cycle RAM (FCRAM), Magnetic Random Access Memory (MRAM), Non-Volatile Random Access Memory (NVRAM), Read Only Memory (ROM), Electrically Programmable Read Only Memory (EPROM), Electrically Erasable Programmable Read-Only Memory (EEPROM), disk storage, Direct Access Storage Device (DASD), Distributed Mass Storage System (DMSS), High Capacity Storage System (HCSS), Hierarchical Storage Management (HSM), Mass Storage Device (MSD), Mass Storage System (MSS), Multiple Virtual Storage (MVS), Network Attached Storage (NAS), Redundant Arrays of Independent Disk (RAID), Storage/System Area Network (SAN), Storage Data Acceleration (SDX), Serial AT Attachment (SATA), Small Computer System Interface (SCSI), Internet Small Computer System Interface (iSCSI), AT Attachment (ATA), Variable Array Storage Technology (VAST), Virtual Storage (VS), Virtual Storage Extended (VSE), Virtual Shared Memory (VSM), processor, multicore processor, Central Processing Unit (CPU), Thread Processor (TP), Floating-point Processing Unit(FPU) , Graphics Processing Unit (GPU), multicore processor, vector processor, Single Instruction, Multiple Data (SIMD) processor, Multiple Instruction Multiple Data (MIMD) processor, communication ports, input-output ports, Ethernet ports, Myrinet ports, gigabit ethernet ports, fiber optic communication ports, networks, network switches, electrical power, battery-backed power supply, Power Supply Unit (PSU), Switching Mode Power Supply (SMPS), Standby Power System (SPS), and a Uninterruptible Power Supply/System(UPS); and
b) restarting the task with improved access to the required computational resource because of the physical or logical proximity of one or more nodes to the computational resource.

12. The method of claim 1, further comprising:
a) reducing availability of at least one computing resource selected from the group consisting of:
data, contiguous memory, cache memory, main memory, Random Access Memory (RAM), Dynamic Random Access Memory (DRAM), Double Datarate Synchronous DRAM (DDR), Synchronous DRAM (SDRAM), memory, Fast-Cycle RAM (FCRAM), Magnetic Random Access Memory (MRAM), Non-Volatile Random Access Memory (NVRAM), Read Only Memory (ROM), Electrically Programmable Read Only Memory (EPROM), Electrically Erasable Programmable Read-Only Memory (EEPROM), disk storage, Direct Access Storage Device (DASD), Distributed Mass Storage System (DMSS), High Capacity Storage System (HCSS), Hierarchical Storage Management (HSM), Mass Storage Device (MSD), Mass Storage System (MSS), Multiple Virtual Storage (MVS), Network Attached Storage (NAS), Redundant Arrays of Independent Disk (RAID), Storage/System Area Network (SAN), Storage Data Acceleration (SDX), Serial AT Attachment (SATA), Small Computer System Interface (SCSI), Internet Small Computer System Interface (iSCSI), AT Attachment (ATA), Variable Array Storage Technology (VAST), Virtual Storage (VS), Virtual Storage Extended (VSE), Virtual Shared Memory (VSM), processor, multicore processor, Central Processing Unit (CPU), Thread Processor (TP), Floating-point Processing Unit(FPU) , Graphics Processing Unit (GPU), multicore processor, vector processor, Single Instruction, Multiple Data (SIMD) processor, Multiple Instruction Multiple Data (MIMD) processor, communication ports, input-output ports, Ethernet ports, Myrinet ports, gigabit ethernet ports, fiber optic communication ports, networks, network switches, electrical power, battery-backed power supply, Power Supply Unit (PSU), Switching Mode Power Supply (SMPS), Standby Power System (SPS), and a Uninterruptible Power Supply/System (UPS);
b) causing at least one task to be relocated from the at least one resource; and
c) using task performance information from at least one reallocated task to improve future allocation of tasks.

13. The method of claim 1, further comprising:
a) associating a run location of at least one computational task with at least one computational resource required by the task, wherein said resource is at least one resource selected from the group consisting of:
data, contiguous memory, cache memory, main memory, Random Access Memory (RAM), Dynamic Random Access Memory (DRAM), Double Datarate Synchronous DRAM (DDR), Synchronous DRAM (SDRAM), memory, Fast-Cycle RAM (FCRAM), Magnetic Random Access Memory (MRAM), Non-Volatile Random Access Memory (NVRAM), Read Only Memory (ROM), Electrically Programmable Read Only Memory (EPROM), Electrically Erasable Programmable Read-Only Memory (EEPROM), disk storage, Direct Access Storage Device (DASD), Distributed Mass Storage System (DMSS), High Capacity Storage System (HCSS), Hierarchical Storage Management (HSM), Mass Storage Device (MSD), Mass Storage System (MSS), Multiple Virtual Storage (MVS), Network Attached Storage (NAS), Redundant Arrays of Independent Disk (RAID), Storage/System Area Network (SAN), Storage Data Acceleration (SDX), Serial AT Attachment (SATA), Small Computer System Interface (SCSI), Internet Small Computer System Interface (iSCSI), AT Attachment (ATA), Variable Array Storage Technology (VAST), Virtual Storage (VS), Virtual Storage Extended (VSE), Virtual Shared Memory (VSM), processor, multicore processor, Central Processing Unit (CPU), Thread Processor (TP), Floating-point Processing Unit(FPU) , Graphics Processing Unit (GPU), multicore processor, vector processor, Single Instruction, Multiple Data (SIMD) processor, Multiple Instruction Multiple Data (MIMD) processor, communication ports, input-output ports, Ethernet ports, Myrinet ports, gigabit ethernet ports, fiber optic communication ports, networks, network switches, electrical power, battery-backed power supply, Power Supply Unit (PSU), Switching Mode Power Supply (SMPS), Standby Power System (SPS), and a Uninterruptible Power Supply/System (UPS); and
b) reallocating or postponing assignment of the at least one computational task to resources to obtain at least one benefit selected from the group consisting of:
reduced power consumption, greater availability of contiguous resources, improved resource capacity to handle additional tasks, improved availability of resources to handle higher-priority tasks.

14. A computer system, comprising a plurality of processors or virtual machines, a plurality of memory units, and one or more input devices and one or more output devices, configured to perform the method of claim 1.

15. A non-transitory computer-readable storage medium with an executable program stored thereon that, upon execution, results in the implementation of operations corresponding to the method of claim 1.

16. A computer-implemented method for obtaining task specifications and performing computation, comprising:
a) providing a generalized actor with a representational construct capable of specifying a first computational task and a second computational task;
b) obtaining specifications of the first computational task and the second computational task from the generalized actor;
c) using a first node to perform a computation to accomplish the first computational task;
d) storing at least one result from the first computational task to local persistent storage associated with the first node;
e) using a second node to perform a computation to accomplish the second computational task, wherein the second computational task requires the at least one result from the first computational task; and
f) enabling the second task to be restarted from data point at which the at least one result from the first computational task is required, if the second task fails to complete within acceptable resource allocations.

17. The method of claim 16, further comprising:
a) providing a generalized actor with a method of specifying task data dependencies; and
b) obtaining at least one task data dependency from the generalized actor.

18. The method of claim 16, further comprising providing the generalized actor with at least one method of specifying tasks selected from the group consisting of: function
definitions, procedure definitions, pragmas, annotations, tags, computer language metadata, computer language macros, computer language objects, computer language templates, declarative language constructs, imperative language constructs, glyphs, symbols, and selection of specified sections of task specification via user-interface choices.

19. The method of claim 16, further comprising providing the generalized actor with at least one method of specifying task data dependencies selected from the group consisting of:
function definitions, procedure definitions, pragmas, annotations, tags, computer language metadata, pragmas, computer language macros, computer language objects, computer language templates, declarative language constructs, imperative language constructs, glyphs, symbols, connection of visible graphical elements, and dependency specification via user-interface choices.

20. A system for obtaining task specifications and performing computation, comprising:
a) means for providing a generalized actor with a representational construct capable of specifying a first computational task and a second computational task;
b) means for obtaining specifications of the first computational task and the second computational task from the generalized actor;
c) means for using at least one first node to perform a computation to accomplish the first computational task;
d) means for storing at least one result from the first computational task to local persistent storage associated with the first node;
e) means for storing at least one result from the first computational task to local persistent storage associated with at least one second node;
f) means for performing a computation on the at least one second node to accomplish the second computational task, wherein the second computational task requires the at least one result from the first computational task;
g) means for enabling the second computational task to be restarted using the result from the first computational task stored in the local persistent storage associated with the at least one second node, if the second computational task fails to complete within specified resource allocations.

21. A method of checkpointing in a computing system, comprising:
a) storing, in a persistent memory associated with a first node of the computing system, input data for a task to be performed at the first node;
b) upon completion of the task, storing the output data from the task at the first node;
c) forwarding the output data to a second node of the computing system as input for a task to be executed on the second node; and
d) storing the output data in a persistent memory associated with the second node prior to executing the task to be executed on the second node.
